(19) United States
(12) Patent Application Publication
(10) Pub. No.: US 2012/0130689 A1
(43) Pub. Date: May 24, 2012

(54) Rigging Calculation Software

(75) Inventor: Derek Moon, Syracuse, NY (US)

(73) Assignee: J. R. CLANCY, INC., Syracuse, NY (US)

(21) Appl. No.: 12/951,590

(22) Filed: Nov. 22, 2010

(51) Int. Cl. G06F 17/50

(52) U.S. Cl. 703/2

(57) ABSTRACT

Rigging calculation software for performing rigging calculations. Preferably, the rigging calculations include the ability to calculate one or more of the following: fleet angle; offset, distance, fleet angle, electrical motor characteristics, recommended sheave pitch; load line capacity; batten capacity; and/or electric motor characteristics. In some preferred embodiments the rigging calculation software is designed to do calculations especially tailored for the design and/or installation of theatrical rigging systems. In some preferred embodiments the rigging calculation software may be accessed over a communication network wirelessly through the internet.

### BACKGROUND OF THE INVENTION

1. Field of the Invention

The present invention relates to systems and methods of performing calculations related to rigging (that is, systems that suspend heavy objects by lines (cables, ropes, etc.) and more particularly to systems and methods of performing calculations related to theatrical rigging.

2. Description of the Related Art

Rigging and theatrical rigging is well known. It is also known that people who install rigging systems must use numerical analysis and calculations to be sure that the rigging system is reliable and will not fail in use. This numerical analysis and these calculations are typically performed in an ad hoc basis using tables of values characterizing the strength and geometry of various components of the rigging system, and also using known calculations to convert these values into meaningful information about what components are required and what loads can be suspended by the rigging system.

Often, the values characterizing rigging components will come from books, but it is believed that computers and the internet may be used both to find the values and the appropriate equations. Computerized calculators (hand calculators, calculators built into computers) may be used, but again, this resort to books and computers is done on an ad hoc basis. The computers and books may be brought to the site of the rigging, or rigging designers may shuttle back and forth between the rigging site and the informational tools of their trade. Of course, the needed calculators, internet-connected computer and/or books may not always be readily available, thereby injecting delay into the design and/or installation of the rigging system.

The issue of good, reliable rigging design is especially critical in the theatre context because a rigging failure, and any attendant human injuries, will be especially public and horrific in this context.

### BRIEF SUMMARY OF THE INVENTION

The present invention is directed to rigging calculation software for performing rigging calculations. Preferably, the rigging calculations include the ability to calculate one or more of the following: fleet angle; offset, distance, fleet angle, electrical motor characteristics, recommended sheave pitch; load line capacity; batten capacity; and/or electric motor characteristics. Other types of rigging calculations and/or rigging catalog information may also be included. In some preferred embodiments the rigging calculation software is designed to do calculations especially tailored for the design and/or installation of theatrical rigging systems. In some preferred embodiments the rigging calculation software may be accessed over a communication network wirelessly through the internet. The storage and/or execution of the software program may be distributed in any manner. For example, in some embodiments the software may be stored only on the end user's computer (e.g. personal digital assistant type computer). However, in at least some preferred embodiments: (i) the software will initially be stored at one or more remote server computer(s); (ii) then, the software will be transferred to the user's computer; and (iii) then, the software will be executed at least substantially completely on the user's computer.

Various embodiments of the present invention may exhibit one or more of the following objects, features and/or advantages:

(i) quicker and more efficient design and/or installation of rigging (especially for theatre rigging); and

(ii) more convenient rigging design and/or installation (especially for theatre rigging);

(iii) enhanced teamwork between rigging designer or installer and rigging hardware supply company (especially for theatre rigging); and/or

(iv) more reliable rigging (especially for theatre rigging).

According to an aspect of the present invention, a software storage device has a set of machine executable instructions and associated data stored thereon. The set of machine executable instructions and associated data includes: a user output module (structured and/or programmed to output data to a user); a user input module (structured and/or located to receive input from the user); and a rigging calculation module. The rigging calculation module is structured and/or programmed to receive at least a first rigging calculation input value from the user through the user input module. The rigging calculation module is further structured and/or programmed to perform a rigging calculation based, at least in part, upon the first rigging calculation input value in order to determine at least a first rigging calculation output value. The rigging calculation module is further structured and/or programmed to output at least a first rigging calculation input value to the user through the user output module.

According to a further aspect of the present invention, a computer system is interconnected in data communication through a communication network. The system includes: a software storage device (having a set of machine executable instructions and associated data stored thereon); and an end user computer (remote from the software storage device).

The end user computer structured and programmed to be capable of data communication with the software storage device over the communication network. The software storage device stores thereon a set of machine executable instructions and associated data including: a user output module (structured and/or programmed to output data to a user), a user input module (structured and/or located to receive input from the user), and a rigging calculation module. The rigging calculation module is structured and/or programmed to receive at least a first rigging calculation input value from the end user computer through the user input module. The rigging calculation module is further structured and/or programmed to perform a rigging calculation based, at least in part, upon the first rigging calculation input value in order to determine at least a first rigging calculation output value. The rigging calculation module is further structured and/or programmed to output at least a first rigging calculation input value to the end user computer through the user output module.

According to a further aspect of the present invention, a computer system is interconnected in data communication through a communication network. The system includes: a software storage device (having a set of machine executable instructions and associated data stored thereon); and an end user computer (remote from the software storage device). The end user computer structured and programmed to be capable of data communication with the software storage device over the communication network. The software storage device stores thereon a set of machine executable instructions and associated data including: a user output module (structured and/or programmed to output data to a user), a user input module (structured and/or located to receive input from the user), and a rigging calculation module. The rigging calculation module is structured and/or programmed to receive at least a first rigging calculation input value from the end user computer through the user input module. The rigging calculation module is further structured and/or programmed to perform a rigging calculation based, at least in part, upon the first rigging calculation input value in order to determine at least a first rigging calculation output value. The rigging calculation module is further structured and/or programmed to output at least a first rigging calculation input value to the end user computer through the user output module. The end user computer is a personal digital assistant. The set of machine executable instructions and associated data is at least partially in the form of an application designed for a personal digital assistant.

### BRIEF DESCRIPTION OF THE DRAWINGS

The present invention will be more fully understood and appreciated by reading the following Detailed Description in conjunction with the accompanying drawings, in which:

FIG. 1 is a schematic view of a first embodiment of a rigging software system according to the present invention;

FIG. 2 is screen display generated by the first embodiment system;

FIG. 3 is screen display generated by the first embodiment system;

FIG. 4 is screen display generated by the first embodiment system;

FIG. 5 is screen display generated by the first embodiment system;

FIG. 6 is screen display generated by the first embodiment system;

FIG. 7 is screen display generated by the first embodiment system;

FIG. 8 is screen display generated by the first embodiment system;

FIG. 9A is screen display generated by the first embodiment system;

FIG. 9B is screen display generated by the first embodiment system;

FIG. 10 is screen display generated by the first embodiment system;

FIG. 11 is screen display generated by the first embodiment system;

FIG. 12 is screen display generated by the first embodiment system; and

FIG. 13 is screen display generated by the first embodiment system.

### DETAILED DESCRIPTION OF THE INVENTION

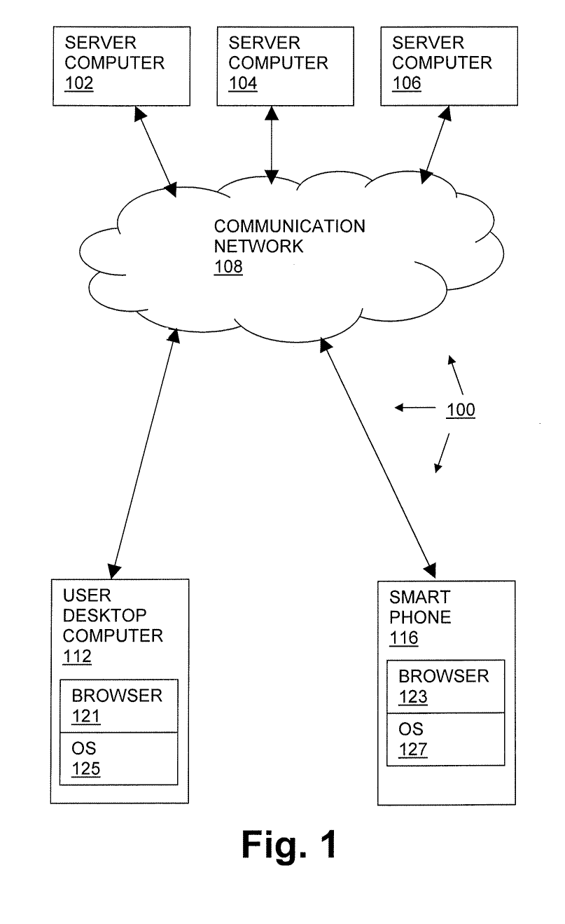

FIG. 1 shows rigging software system 100, including: server computers 102,104,106; communication network 108; user desktop computer 112; and smartphone 116. User desktop computer includes browser 112; and desktop operating system (“OS”) 125. Smartphone 116 includes smartphone browser 123 and smartphone OS 127. Communication network 108 is preferably the internet, but could be any other sort of communication network now known or to be developed in the future.

Smartphone software (that is machine executable instructions and associated data) is stored on a software storage device (see DEFINITIONS section) distributed between and among server computers 102,104,106. A user of desktop computer access this software by: (i) downloading it from the server computers through communication network 108; (ii) accessing the software remotely as it remotely runs on the server computers; and/or (iii) some combination of (i) and (ii).

Using the software through desktop computer 112 has advantages in that this computer may have much more processing power, user-friendlier user input and output devices and other capabilities to better support advanced features like real time video or a 3D CAD model of a theatre space rigging site. On the other hand, using the software through a personal digital assistant (“PDA”), like smartphone 116, has the advantage that the device may be conveniently carried to all locations where a rigging designer and/or installer goes, such as his office or the site of the rigging. Some PDA's do not have smartphone capabilities, but smartphone-type PDA's are preferable because of their telephone-type capabilities. For example, if the rigging calculations lead the rigging designer and/or installer to order additional rigging hardware by telephone, then this can be accomplished by a smartphone. It is noted that the data communication (see DEFINITIONS section) between the servers the desktop, the smartphone may be wired or wireless.

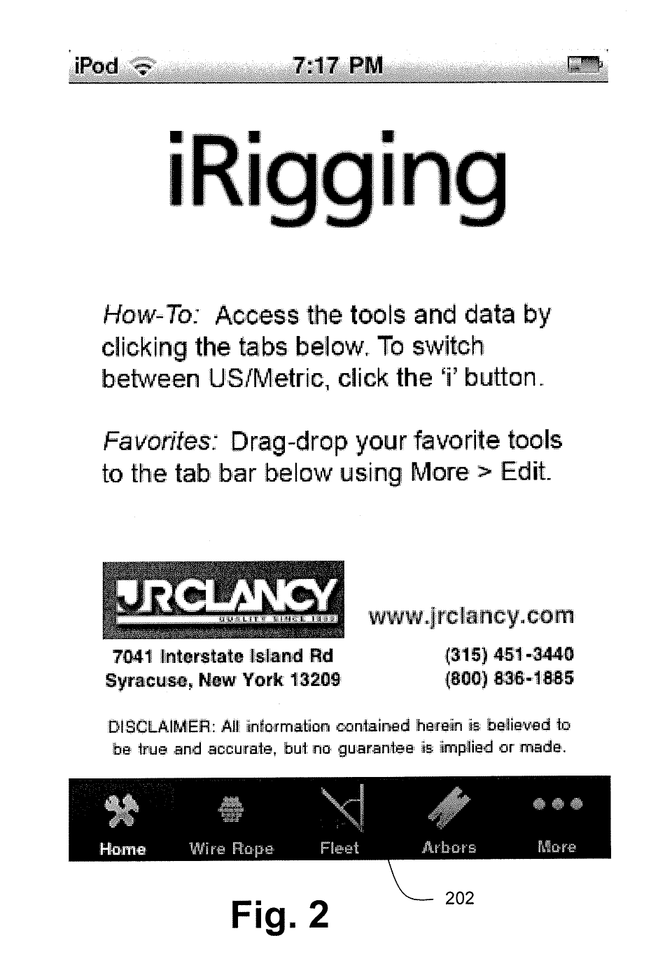

FIG. 2 shows home page display 202 generated by the rigging software. It is noted that contact information for the rigging hardware manufacturer appears, which helps cultivate close relationships between the rigging designer and/or installer and the rigging hardware supplier. At the bottom of display 202 is a touchscreen menu so that the user can quickly access the desired portion of the rigging calculation software. It is emphasized that the particular touchscreen options shown at the bottom of display 202 are preferably designed to reflect which functions of the rigging software are likely to be most frequently accessed by a user, and may be different as different specific embodiments according to the present invention are developed. The “more” button option on the touchscreen shows that user options can be hierarchically arranged, similar to “pulldown menus,” “ribbons” and tabbed pop-up boxes present in conventional software user interfaces. the user options are not required to be presented as a bar of touchscreen buttons, but may involve any user interface now know, or developed in the future (for example, voice control).

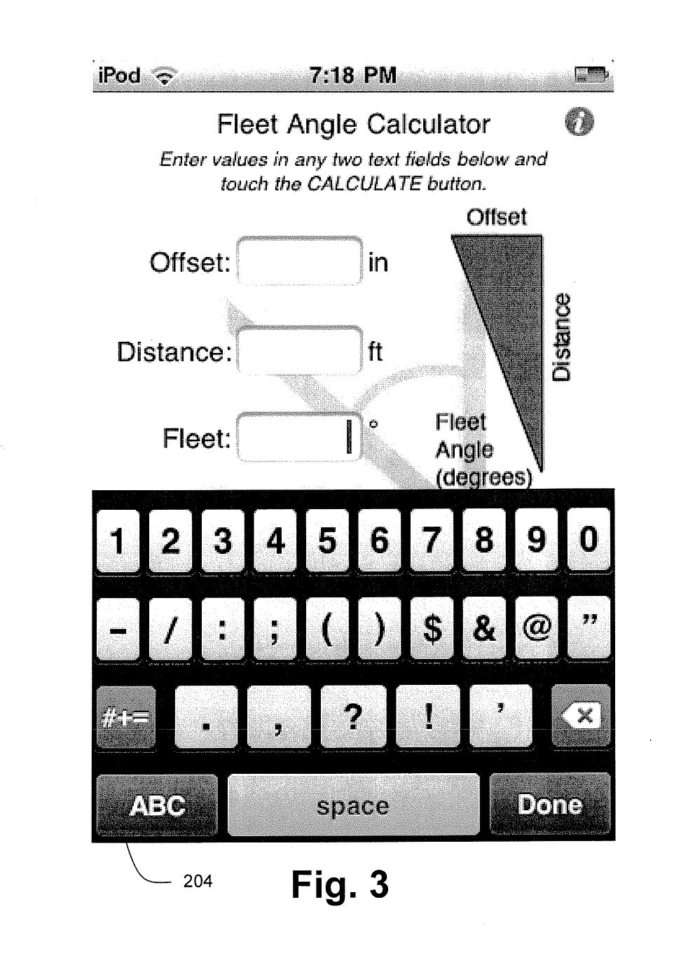

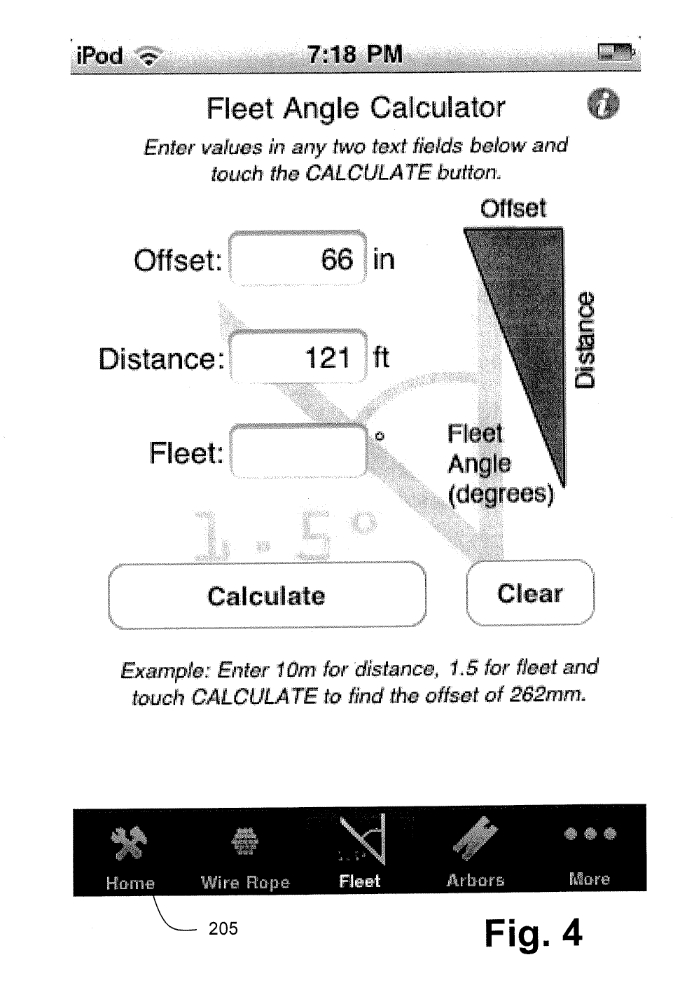

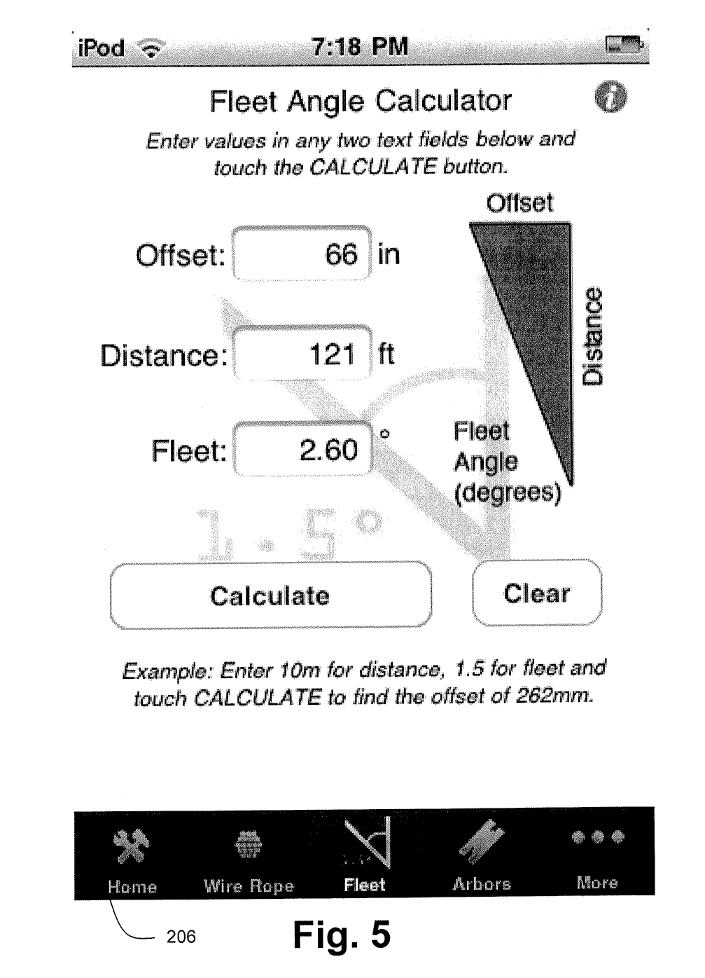

FIG. 3 shows a first fleet angle calculator display 204. As is known in the art of theatrical rigging design, if any two of the quantities offset, distance and/or fleet angle are known, then the third quantity can be calculated from this by known trigonometric equations. Display 204 makes it convenient and easy to do just that. The user touches the field corresponding to the known quantity she wants to enter. In display 204, the cursor that has appeared in the field for fleet angle indicates that the user is preparing to enter a fleet angle. The touchscreen keypad towards the bottom of display 204 allows the user to enters the appropriate quantities. Alternatively, other user input devices could be used. As shown in FIG. 4, second fleet angle calculator display 205, the user has entered the two quantities which she knows. As shown in FIG. 5, third fleet angle calculator display displays the unknown quantity (in this example, the fleet angle) has been calculated by the rigging software.

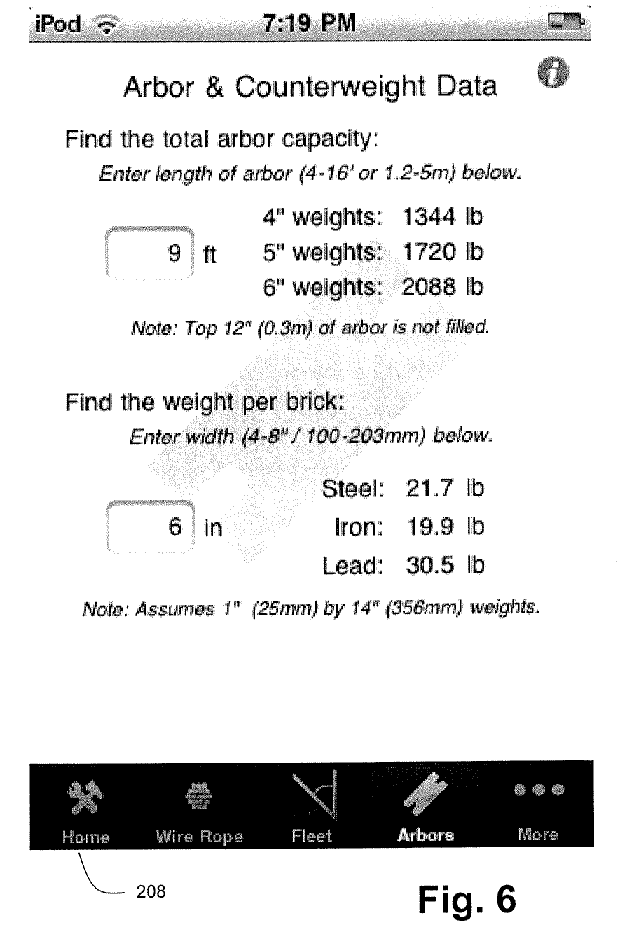

As shown in FIG. 6, the user has now selected the “Arbors” selection on the touchscreen menu and the rigging software has generated arbor display 208. This portion of the rigging software allows the user to calculate: (i) the maximum weight that an arbor of a predetermined length can hold; and (ii) the weight per counterweight brick for standard profile bricks made of various materials. The rigging software may determine these quantities either by means of a look-up table that stores appropriate output values for all predetermined input values, or by calculating these quantities mathematically using equations known in the art of theatrical rigging design.

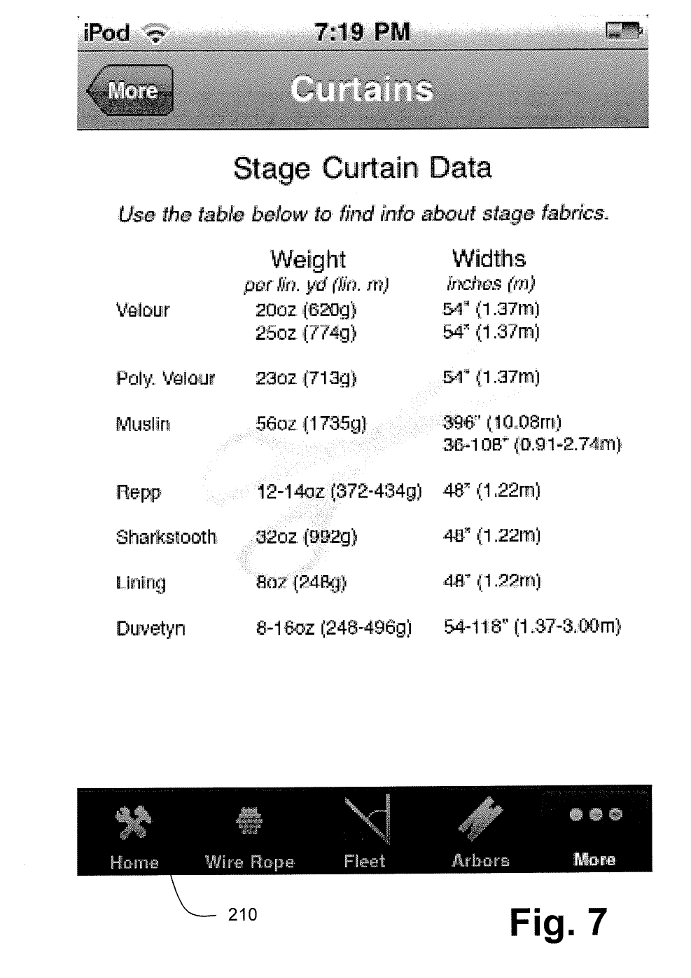

As shown in FIG. 7, the user has now selected one of the options from the “More” option on the touchscreen menu and the rigging software has generated curtain fabric display 210. This portion of the rigging software displays weights and widths of various stage fabric materials.

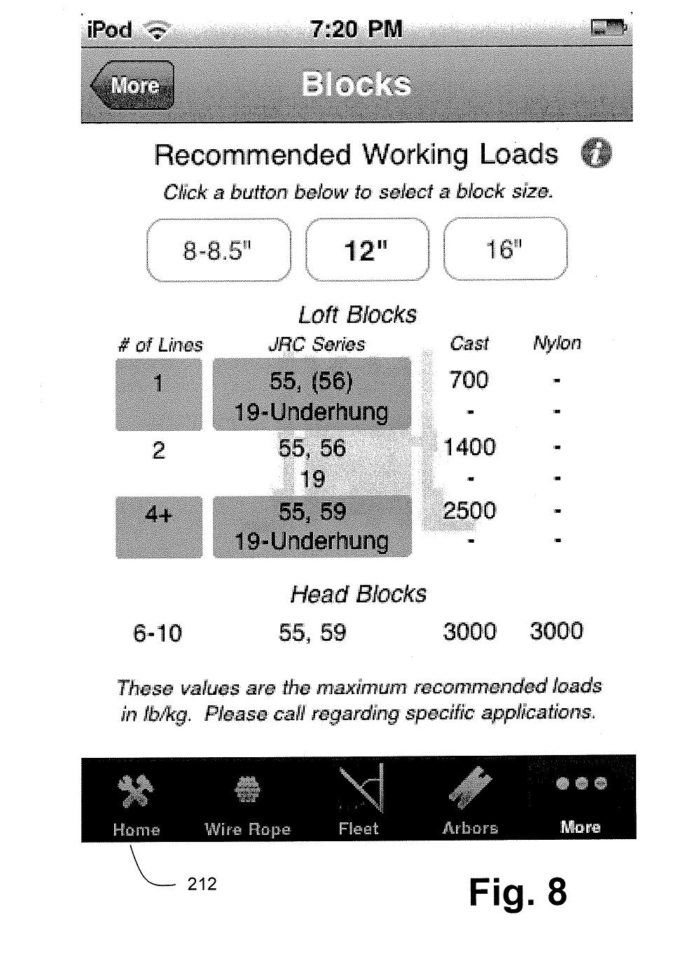

As shown in FIG. 8, the user has now selected one of the options from the “More” selection on the touchscreen menu and the rigging software has generated working loads display 212. On this display, the user has selected her block size to be 12″, as indicated by the highlighting of this block size option. In response, the rigging software outputs recommended maximum working loads for both cast and nylon loft blocks and head blocks. This helps the designer and/or installer ensure that the pulleys of the rigging system will not fail in use.

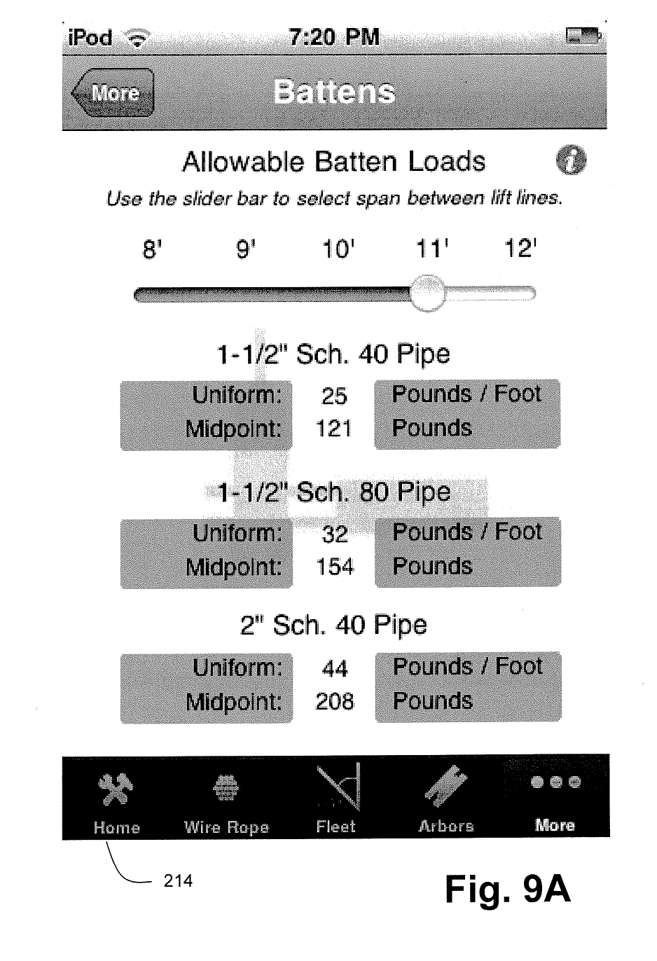

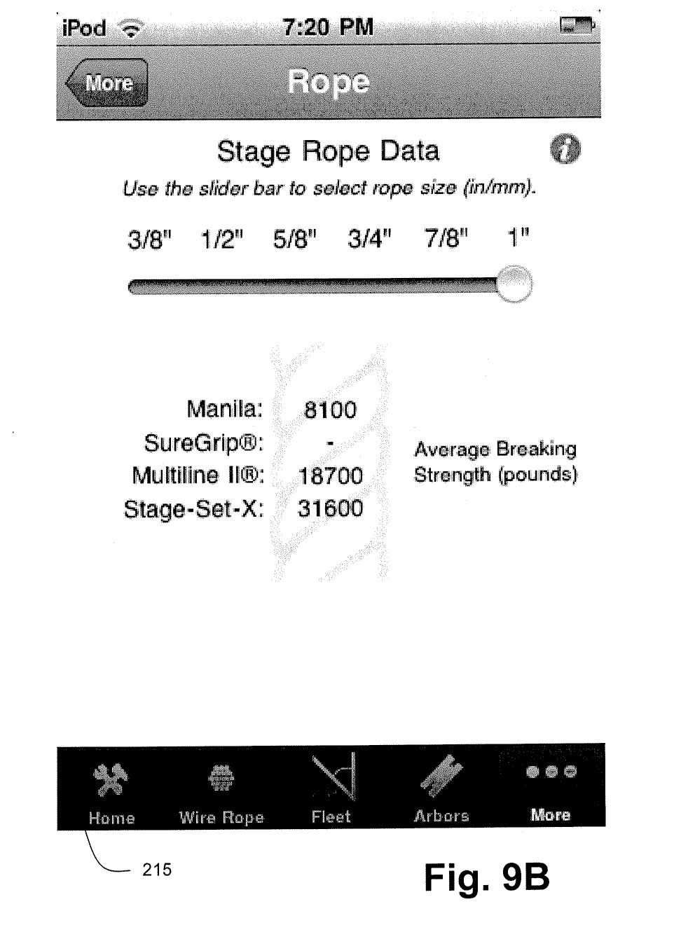

As shown in FIG. 9A, the user has now selected another option from the “More” selection on the touchscreen menu and the rigging software has generated battens display 214. On this display, the user has selected the batten length to be 11′, as indicated by the slider toward the top of display 214. In response, the rigging software outputs recommended maximum uniform and loads for the selected battens, corresponding to various standardized batten pipe sizes. This helps the designer and/or installer ensure that the battens of the rigging system will not fail in use.

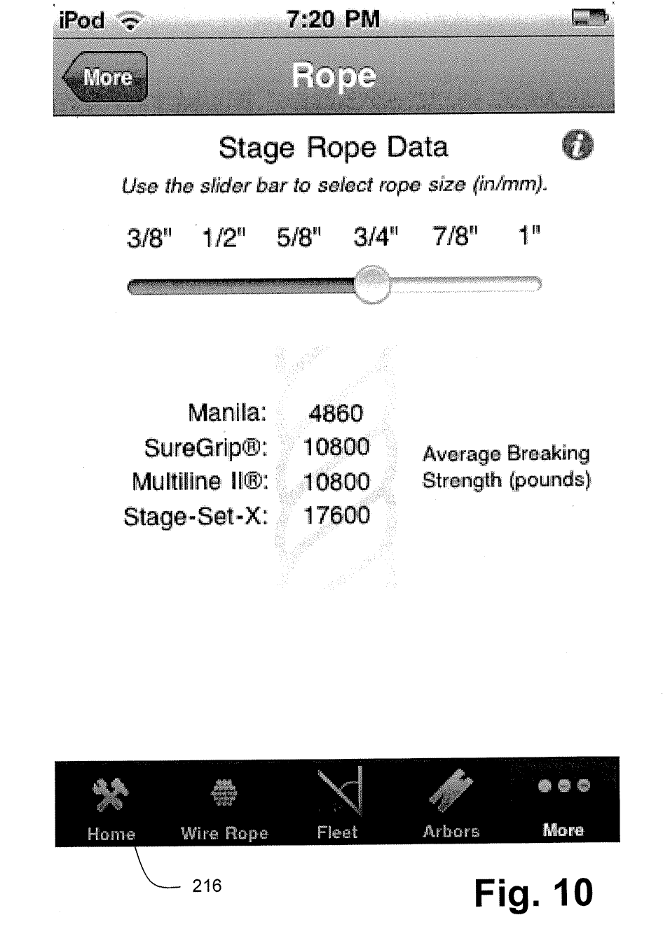

As shown in FIG. 9B, the user has now selected another option from the “More” selection on the touchscreen menu and the rigging software has generated first rope display 215. On this display, the user has selected the rope size to be 1″, as indicated by the slider toward the top of display 215. In response, the rigging software outputs the average breaking strengths for various types of ropes. This helps the designer and/or installer ensure that the ropes of the rigging system will not fail in use. As shown in FIG. 10, the user slided the slider to select a different rope size of ¾″. In response, the rigging software has generated second rope display 216 in order to output to the user the lower average breaking strengths for this smaller rope size. In this way, the user can iteratively refine her rigging system design.

By comparing displays 215 and 216, the user can also determine that SureGrip(R) rope is available in the ¾″ size, but not the 1″ size. This is an example of the rigging software providing rigging hardware catalog information regarding available hardware. In some embodiments of the present invention, the catalog information might be much more detailed, and include things like available inventory, costs, shipping costs, shipping times and the like. The catalog information might further include information like frequently asked questions for a given piece of hardware or user reviews. By providing this catalog information as an integral part of rigging calculation software, it can not only be made much more convenient to access (for example, on a smartphone at a rigging site), but can also be made more comprehensive and interactive than an old fashioned catalog printed on paper and distributed by the postal service.

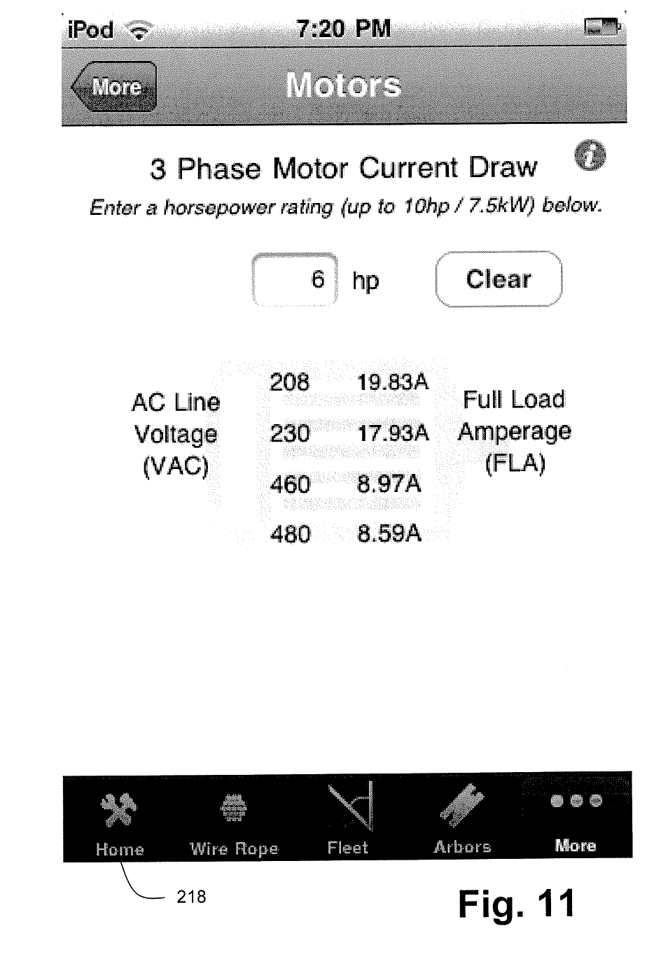

As shown in FIG. 11, the user has now selected one of the options from the “More” selection on the touchscreen menu and the rigging software has generated motor characteristics display 218. On this display, the user has selected the motor size to be 6 horsepower, as indicated by the numbers that have been entered into the motor power field toward the top of display 218. In response, the rigging software output line voltages and full load amperages associated with that kind of motor. This helps the designer and/or installer ensure that the electrical portions (for example, power circuitry) of the rigging system will not fail in use.

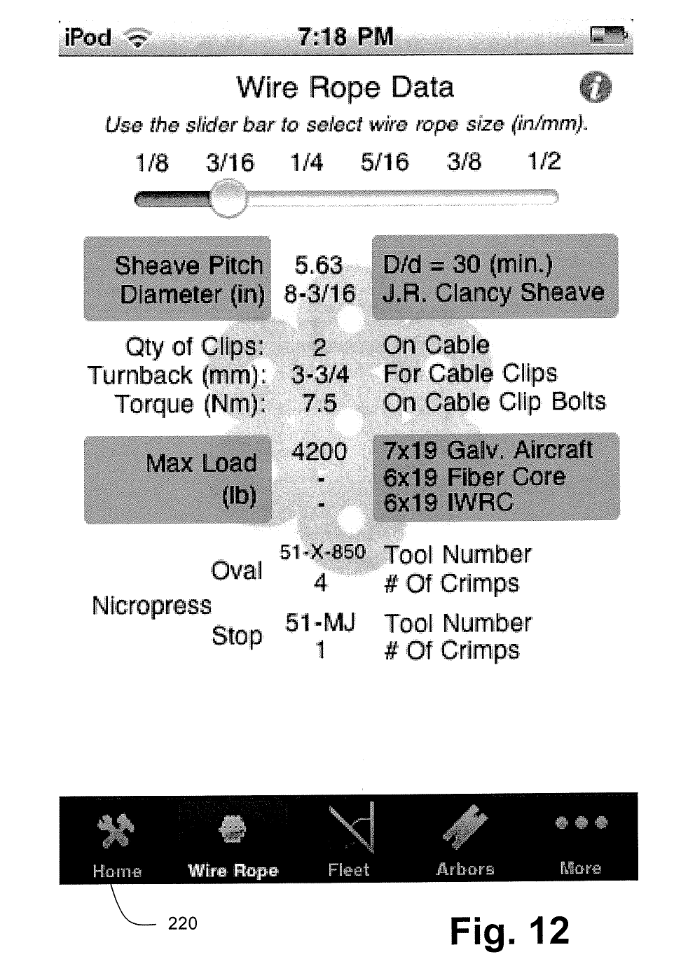

As shown in FIG. 12, the user has now selected “Wire Rope” selection on the touchscreen menu and the rigging software has generated wire rope display 220. On this display, the user has selected the wire rope size to be 3/16 inches, as indicated by the position of the slider toward the top of display 218. In response, the rigging software calculates and outputs various wire rope related parameters, such as: (i) sheave pitch; (ii) sheave diameter; (iii) quantity of clips; (iv) turnback; (v) torque; (vi) maximum load (for various wire rope types); and (vii) nicropress oval and stop tool numbers. This helps the designer and/or installer ensure that the wire rope of the rigging system will not fail in use.

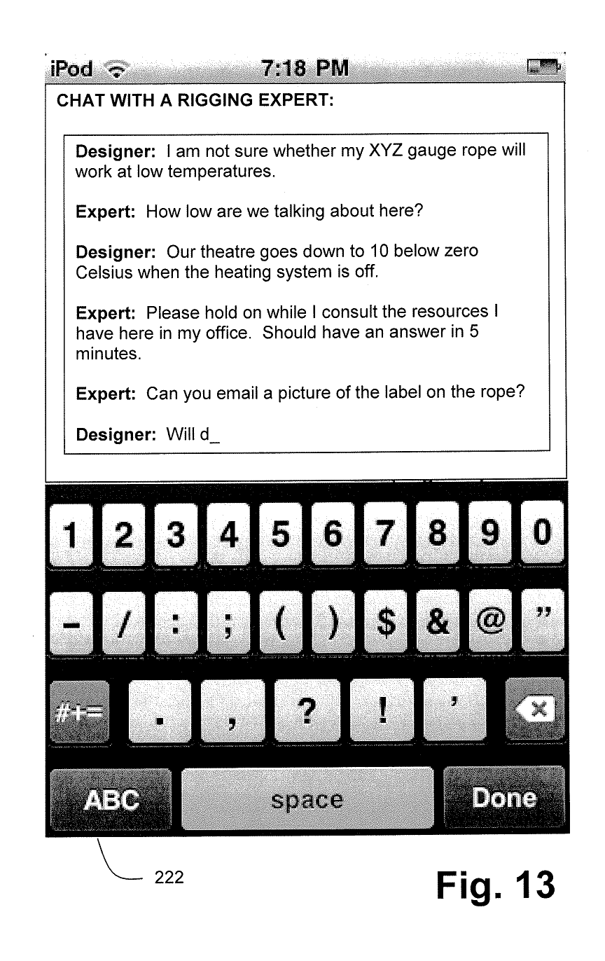

FIG. 13 shows communication display 222 corresponding to a user-to-hardware-provider communication module. In this particular embodiment, this communication module is specifically for text based chat, but it could take on other forms like video chat, a telephonic “hotline,” email and so on. As shown in display 222, the rigging designer is asking questions of the expert representative of the hardware provider company. This feature (which is not necessarily present in all embodiments of the present invention) can help foster a closer working relationship between a rigging designer and her hardware provider, and can also result in the design and installation of even safer and more reliable rigging systems. By placing the communication module right into the rigging software itself, it will be “top-of-mind” for the designer to contact the hardware provider when a question or concern comes up, and the user will not be forced to leave the rigging software and open up some kind of separate communication channel with the hardware provider.

In some preferred embodiments, the rigging software is provided as a free application for a smartphone, such as through an online applications store. However, in other embodiments there may be a charge for using the software (one time charge, running charge). This is especially so in more sophisticated embodiments that include computer aided design (“CAD”) programs in the rigging software. More sophisticated programs, that would allow virtual modeling of an entire theatre and of performances in the theatre may be useful, but this kind of software is expensive to develop and provide, so it may be appropriate to charge for use as the sophistication level goes up.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Electrically Connected: means either directly electrically connected, or indirectly electrically connected, such that intervening elements are present; in an indirect electrical connection, the intervening elements may include inductors and/or transformers.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (ii) in a single proximity within a larger piece of software code; (iii) located within a single piece of software code; (iv) located in a single storage device, memory or medium; (v) mechanically connected; (vi) electrically connected; and/or (vii) connected in data communication.

System: is limited to systems that are considered as patent-eligible subject matter under applicable law and does not include any systems that are not considered as patent-eligible subject matter under applicable law.

Method: is limited to methods that are considered as patent-eligible subject matter under applicable law and does not include any methods that are not considered as patent-eligible subject matter under applicable law.

Software storage device: any device (or set of devices) capable of storing computer code in a non-transient manner in one or more tangible storage medium(s); “software storage device” does not include any device that stores computer code only as a signal.

Calculate: determine by performing a mathematical calculation, or by reference to a lookup table.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

What is claimed is:

1. A software storage device having a set of machine executable instructions and associated data stored thereon, the set of machine executable instructions and associated data comprising:
a user output module structured and/or programmed to output data to a user;
a user input module, structured and/or located to receive input from the user; and
a rigging calculation module;
wherein:
the rigging calculation module is structured and/or programmed to receive at least a first rigging calculation input value from the user through the user input module;
the rigging calculation module is further structured and/or programmed to perform a rigging calculation based, at least in part, upon the first rigging calculation input value in order to determine at least a first rigging calculation output value; and
the rigging calculation module is further structured and/or programmed to output at least a first rigging calculation input value to the user through the user output module.

2. The device of claim 1 wherein the a set of machine executable instructions and associated data further comprises a rigging hardware catalog information module, wherein the rigging hardware calculation module is structured and/or programmed to output rigging hardware catalog information to the user through the user output module.

3. The device of claim 1 wherein:
the set of machine executable instructions and associated data further comprises a communications module; and
the communications module is structured and/or programmed to provide a communication channel between the user and a rigging hardware provider.

4. The device of claim 3 wherein the communications module is further structured and/or programmed to provide an at least substantially real time communication channel between the user and the rigging hardware provider.

5. The device of claim 1 wherein:
the rigging calculation module is further structured and/or programmed to receive a second rigging calculation input value from user through the user output module, with the first and second rigging calculation input values respectively corresponding to two of the following rigging parameters: offset, distance and fleet angle;
the rigging calculation module is further structured and/or programmed to calculate the parameter a calculated parameter for the value of the parameter that has not been input by the user based, at least in part, upon the first rigging calculation input value and the second rigging calculation input value in order; and
the rigging calculation module is further structured and/or programmed to output the calculated parameter to the user through the user output module.

6. The device of claim 1 wherein:
the first rigging calculation input value corresponds to power rating of a motor; and
the first rigging calculation output value corresponds to an electrical characteristic of the motor.

7. The device of claim 1 wherein:
the first rigging calculation input value corresponds to the size of a selected load line; and
the first rigging calculation output value corresponds to a recommended sheave pitch associated with the selected load line.

8. The device of claim 1 wherein:
the first rigging calculation input value corresponds to the size of a selected load line; and
the first rigging calculation output value corresponds to a recommended sheave diameter associated with the selected load line.

9. A computer system interconnected in data communication through a communication network, the system comprising:
a software storage device having a set of machine executable instructions and associated data stored thereon; and
an end user computer, remote from the software storage device;
wherein:
the end user computer is structured and/or programmed to be capable of data communication with the software storage device over the communication network;
the software storage device stores thereon a set of machine executable instructions and associated data comprising:
a user output module structured and/or programmed to output data to a user,
a user input module, structured and/or located to receive input from the user, and
a rigging calculation module;
the rigging calculation module is structured and/or programmed to receive at least a first rigging calculation input value from the end user computer through the user input module;
the rigging calculation module is further structured and/or programmed to perform a rigging calculation based, at least in part, upon the first rigging calculation input value in order to determine at least a first rigging calculation output value; and
the rigging calculation module is further structured and/or programmed to output at least a first rigging calculation input value to the end user computer through the user output module.

10. The system of claim 9 wherein the end user computer is structured and/or programmed to data communicate through the communication network in a wireless manner.

11. The system of claim 10 wherein:
the end user computer is a personal digital assistant; and
a set of machine executable instructions and associated data is at least partially in the form of an application designed for a personal digital assistant.

12. The system of claim 11 wherein the personal digital assistant is a smartphone.

13. The system of claim 9 wherein the communication network comprises the internet.

14. A computer system interconnected in data communication through a communication network, the system comprising:
a software storage device having a set of machine executable instructions and associated data stored thereon; and
an end user computer, remote from the software storage device;
wherein:
the end user computer structured and programmed to be capable of data communication with the software storage device over the communication network;
the software storage device stores thereon a set of machine executable instructions and associated data comprising:
a user output module structured and/or programmed to output data to a user,
a user input module, structured and/or located to receive input from the user, and
a rigging calculation module;
the rigging calculation module is structured and/or programmed to receive at least a first rigging calculation input value from the end user computer through the user input module;
the rigging calculation module is further structured and/or programmed to perform a rigging calculation based, at least in part, upon the first rigging calculation input value in order to determine at least a first rigging calculation output value;
the rigging calculation module is further structured and/or programmed to output at least a first rigging calculation input value to the end user computer through the user output module.
the end user computer is a personal digital assistant; and
the set of machine executable instructions and associated data is at least partially in the form of an application designed for a personal digital assistant.

15. The system of claim 14 wherein the a set of machine executable instructions and associated data further comprises a rigging hardware catalog information module, wherein the rigging hardware calculation module is structured and/or programmed to output rigging hardware catalog information to the user through the user output module.

16. The system of claim 14 wherein:
the set of machine executable instructions and associated data further comprises a communications module;
the communications module is structured and/or programmed to provide a communication channel between the user and a rigging hardware provider;
the communications module is further structured and/or programmed to provide an at least substantially real time communication channel between the user and the rigging hardware provider.

17. The system of claim 14 wherein:
the rigging calculation module is further structured and/or programmed to receive a second rigging calculation input value from user through the user output module, with the first and second rigging calculation input values respectively corresponding to two of the following rigging parameters: offset, distance and fleet angle;
the rigging calculation module is further structured and/or programmed to calculate the parameter a calculated parameter for the value of the parameter that has not been input by the user based, at least in part, upon the first rigging calculation input value and the second rigging calculation input value in order; and
the rigging calculation module is further structured and/or programmed to output the calculated parameter to the user through the user output module.

18. The system of claim 14 wherein:
the first rigging calculation input value corresponds to power rating of a motor; and
the first rigging calculation output value corresponds to an electrical characteristic of the motor.

19. The system of claim 14 wherein:
the first rigging calculation input value corresponds to the size of a selected load line; and
the first rigging calculation output value corresponds to a recommended sheave pitch associated with the selected load line.

20. The system of claim 14 wherein:
the first rigging calculation input value corresponds to the size of a selected load line; and
the first rigging calculation output value corresponds to a recommended sheave diameter associated with the selected load line.
